(19) United States
(12) Patent Application Publication
(10) Pub. No.: US 2026/0256198 A1
(43) Pub. Date: Sep. 3, 2026

(54) AEROSOL-GENERATING DEVICE WITH PLUG EXTRACTION

(71) Applicant: Philip Morris Products S.A., Neuchâtel (CH)

(72) Inventors: Jennifer Ernestine Emma PLUN, Peseux (CH); Gérard Edmond ZUBER, Boulens (CH); Özgür ÖZSUN, Kilchberg (CH); Enrico TURRINI, Neuchâtel (CH)

(73) Assignee: Philip Morris Products S.A., Neuchâtel (CH)

(21) Appl. No.: 19/494,106

(22) PCT Filed: Sep. 9, 2024
(86) PCT No.: PCT/EP2024/075095

§ 371 Date: Dec. 17, 2025

(30) Foreign Application Priority Data
Sep. 14, 2023 (EP) 23197518.6

(51) Int. Cl. A24F 40/42; A24F 40/20; A24F 40/46; A24F 40/465; A24F 40/60; H05B 3/06

(52) U.S. Cl. CPC A24F 40/42; A24F 40/20; A24F 40/46; A24F 40/465; A24F 40/60; H05B 3/06

(57) ABSTRACT

An aerosol-generating device is provided, the device including: a heating module configured to receive a substrate plug comprising aerosol-forming substrate; a movable insertion element; and an axially movable extraction element, the insertion element and the extraction element being mechanically coupled such that the insertion element and the extraction element are movable together between an open position and a closed position, the insertion element being configured to push the substrate plug in a distal direction into the heating module when moved from the open position to the closed position, and the extraction element being configured to push the substrate plug in a proximal direction out of the heating module when moved from the closed position to the open position.

The present invention relates to an aerosol-generating device and to an aerosol-generating system.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of a substrate plug. The substrate plug may have a rod shape for insertion of the substrate plug into a cavity, such as a heating chamber, of the aerosol-generating device. A heating element may be arranged in or around the heating chamber for heating the aerosol-forming substrate once the aerosol-generating article is inserted into the heating chamber of the aerosol-generating device.

It would be desirable to have an aerosol-generating device with improved insertion of the substrate plug into the aerosol-generating device. It would be desirable to have an aerosol-generating device with improved removal of the substrate plug from the aerosol-generating device.

According to an embodiment of the invention there is provided an aerosol-generating device that may comprise a heating module. The heating module may be configured to receive a substrate plug comprising aerosol-forming substrate. The aerosol-generating device may further comprise a movable insertion element and an axially movable extraction element. The insertion element and the extraction element may be mechanically coupled such that the insertion element and the extraction element may be movable together between an open position and a closed position. The insertion element may be configured to push the substrate plug in a distal direction into the heating module when moved from the open position to the closed position. The extraction element may be configured to push the substrate plug in a proximal direction out of the heating module when moved from the closed position to the open position.

According to an embodiment of the invention there is provided an aerosol-generating device comprising a heating module. The heating module is configured to receive a substrate plug comprising aerosol-forming substrate. The aerosol-generating device further comprises a movable insertion element and an axially movable extraction element. The insertion element and the extraction element are mechanically coupled such that the insertion element and the extraction element are movable together between an open position and a closed position. The insertion element is configured to push the substrate plug in a distal direction into the heating module when moved from the open position to the closed position. The extraction element is configured to push the substrate plug in a proximal direction out of the heating module when moved from the closed position to the open position.

The combined insertion element and extraction element enables improved insertion of the substrate plug into the heating module when moving the insertion element and the extraction element from the open position to the closed position. Further, the combined insertion element and extraction element enables improved extraction of the substrate plug from the heating module when moving the insertion element and the extraction element from the closed position to the open position. The mechanical coupling between the insertion element and the extraction element facilitates that these two elements are moved together without the need of separately moving the insertion element from the extraction element.

The heating module may comprise a heating element. The heating module may be hollow. The heating module may be tubular. The heating module may be cylindrical. The heating module may comprise a heating chamber. The heating element may be at least partly arranged surrounding the heating chamber of the heating module. The heating element may be arranged fully surrounding the heating chamber. The heating chamber of the heating module may have an inner diameter corresponding to the outer diameter of a substrate plug.

The substrate plug may be an aerosol-generating article. The substrate plug may comprise a substrate portion comprising the aerosol-forming substrate. The substrate plug may comprise further portions such as one or more further portions and a cooling portion. The cooling portion may have a hollow tubular shape. The cooling portion may be arranged downstream of the substrate portion. A filter portion may be denoted as mouthpiece filter and arranged as the most downstream portion of the substrate plug. A further filter portion may be denoted as front plug and may be arranged at the most upstream end of the substrate plug. A tipping paper may surround one or more portions of the substrate plug. In a particularly preferred embodiment, however, the substrate plug comprises only the substrate portion and optionally a wrapping paper being arranged surrounding the substrate portion. In other words, in a particularly preferred embodiment, the substrate plug is a very simple substrate plug essentially only consisting of the aerosol-forming substrate without the need of further substrate portions such as further portions or cooling portions.

The insertion element may be configured to push the substrate plug into the heating chamber of the heating module. The insertion element may have a distal end face configured to push the substrate plug into the heating chamber of the heating module. The distal end face may be flat. The distal end face may be ring-shaped. The airflow channel may be arranged surrounded by the ring-shaped distal end face. The distal end face may be circular. The outer diameter of the distal end face may correspond to an outer diameter of the substrate plug. The insertion element may be cylindrical. An outer diameter of the insertion element may correspond to the outer diameter of the substrate plug.

The extraction element may be configured to push the substrate plug out of the heating chamber of the heating module. The extraction element may have a proximal end face configured to push the substrate plug out of the heating chamber of the heating module. The proximal end face of the extraction element may be flat. The proximal end face may be ring-shaped. The airflow channel may be arranged surrounded by the ring-shaped proximal end face. The proximal end face may be circular. The outer diameter of the proximal end face may correspond to the outer diameter of the substrate plug. The extraction element may be cylindrical. An outer diameter of the extraction element may correspond to the outer diameter of the substrate plug.

The movement of the insertion element and the extraction element from the open position to the closed position may be a closing movement. This movement may be a movement in a distal direction. The movement of the insertion element and the extraction element from the closed position to the open position may be an opening movement. This movement may be a movement in a proximal direction.

In the open position, the substrate plug may be insertable and removable from the aerosol-generating device. In the closed position, the substrate plug may be arranged within the heating module so as to be heated for aerosol generation.

The aerosol-generating device may comprise a controller preventing operation of the heating module in the open position of the insertion element and the extraction element. The controller of the aerosol-generating device may be configured to enable operation of the heating module in the closed position.

A substrate plug receiving region may be arranged between the insertion element and the extraction element.

The heating module may be fluidly connected with the substrate plug receiving region. The substrate plug receiving region may have a cylindrical shape. The substrate plug receiving region may have a shape corresponding to the outer perimeter of the substrate plug. In other words, the substrate plug may sit flush within the substrate plug receiving region. This may improve heating efficiency of the aerosol-forming substrate of the substrate plug during heating of the aerosol-forming substrate by the heating module in the closed position.

An inner diameter of the substrate plug receiving region may correspond to the outer diameter of the substrate plug. An outer diameter of the substrate plug receiving region may correspond to the outer diameter of the insertion element. The outer diameter of the substrate plug receiving region may correspond to the outer diameter of the extraction element.

The substrate plug receiving region may have an inner diameter of between 2 mm and 12 mm, preferably between 4 mm and 10 mm, more preferably between 5 mm and 8 mm. The length of the substrate plug receiving region may be between 6 mm and 24 mm, preferable between 8 mm and 20 mm, more preferably between 10 mm and 18 mm. The substrate plug may have an outer diameter of between 2 mm and 12 mm, preferably between 4 mm and 10 mm, more preferably between 5 mm and 8 mm. The length of the substrate plug may be between 6 mm and 24 mm, preferable between 8 mm and 20 mm, more preferably between 10 mm and 18 mm.

The substrate plug receiving region may be accessible for insertion and removal of the substrate plug in the open position.

The substrate plug receiving region may be arranged centrally within the heating module and may be configured as a heating chamber in the closed position. In the closed position, the substrate plug receiving region may be the heating chamber of the heating module or may occupy the same space as the heating chamber of the heating module.

One or both of the insertion element and the extraction element may be manufactured from heat resistant material. One or both of the insertion element and the extraction element may be manufactured from material with a low thermal conductivity. One or both of the insertion element and the extraction element may be manufactured from material selected from the group of ceramic materials or temperature resistant polymer (e.g. PEEK, PSU . . . ).

An insertion force of the insertion element towards the substrate plug may be between 0.1 N and 30 N, preferably between 0.3 N and 10 N, more preferably between 1N and 5 N. An extraction force of the extraction element towards the substrate plug may be between 0.1 N and 30 N, preferably between 0.3 N and 10 N, more preferably between 1 N and 5 N.

The insertion element may comprise an airflow channel in fluid contact with the substrate plug receiving region.

The airflow channel of the insertion element may be arranged along a longitudinal axis of the insertion element. In other words, the airflow channel of the insertion element may be a central airflow channel of the insertion element. The longitudinal axis of the insertion element may be identical to a longitudinal axis of the substrate plug receiving region. The longitudinal axis of the substrate plug receiving region may be identical to a longitudinal axis of the extraction element.

The extraction element may comprise an airflow channel in fluid contact with the substrate plug receiving region.

The airflow channel of the extraction element may be arranged along a longitudinal axis of the extraction element. In other words, the airflow channel of the extraction element may be a central airflow channel of the extraction element.

The insertion element may be part of a mouthpiece of the aerosol-generating device. The insertion element may be integrally formed with the mouthpiece. The mouthpiece may thus have a double functionality of enabling a user to draw the generated aerosol through the mouthpiece and of inserting the substrate plug into the heating module by means of the mouthpiece.

The aerosol-generating device may further comprise a connection shaft mechanically connecting the insertion element and the extraction element. The connection shaft may have an extension axis that may be parallel to an extension axis of one or both of the insertion element and the extraction element.

The connection shaft may be longitudinal. The connection shaft may be rigid. The connection shaft may have a distal end. The distal end of the connection shaft may be mechanically connected with the extraction element. The connection shaft may have a proximal end. The proximal end of the connection shaft may be mechanically connected with the insertion element.

The insertion element may be pivotally mounted on the connection shaft to enable a pivotal movement in a plane perpendicular to the extension axis of the connection shaft. The extension axis of the connection shaft may be parallel or along the longitudinal axis of the substrate plug receiving region.

The insertion element may be rotated in the plane perpendicular to the extension axis of the connection shaft to enable insertion of the substrate plug into the substrate plug receiving region. The insertion of the substrate plug may be enabled from a position proximal of the substrate plug receiving region and in a distal direction into the substrate plug receiving region. After insertion of the substrate plug into the substrate plug receiving region, the insertion element may be rotated back into the initial position. Thereby, the substrate plug insertion area may be closed. The insertion element then may be enabled to push the substrate plug into the heating module by means of a distal movement of the insertion element.

The insertion element may be configured axially movable.

The insertion element may be configured for two separate movements. The first movement may be an axial movement to enable pushing of the substrate plug into the heating module. The second module may be a pivotal movement to open the insertion element for insertion and removal of the substrate plug into/from the substrate plug receiving region. When the insertion element is pivotally moved into the open position, this may be denoted as open position of the insertion element. When the insertion element is rotated back into the initial position and distally pushed so as to push the substrate plug into the heating module, this may be denoted as closed position. In other words, the transition from the open position to the closed position may comprise two movements of the insertion element, namely a pivotal movement to close of the substrate plug receiving region and a distal axial movement to push the substrate plug into the heating module.

The insertion element may be pivotally mounted on the aerosol-generating device to enable a pivotal movement between the open position and the closed position in a plane parallel to a longitudinal axis of the aerosol-generating device.

This is an alternative to the pivotally movement of the insertion element in the plane perpendicular to the extension axis of the connection shaft. In this embodiment the two-part movement may be replaced by a single pivotal movement of the insertion element in the plane parallel to the longitudinal axis of the aerosol-generating device. This pivotal movement may open the substrate plug receiving region, which may be denoted as open position. The pivotally movement may at the same time lead to the extraction element pushing the substrate plug out of the heating module to enable extraction of the spent substrate plug. A closing pivotal movement of the insertion element may enable closing of the substrate plug receiving region. At the same time, the closing pivotal movement may push the substrate plug into the heating module, which may be denoted as the closed position.

The pivotal movement of the insertion element may be a lid-like movement between the open position and the closed position.

Particularly preferred, the insertion element is arranged in or integrally formed with the mouthpiece and the mouthpiece can be removed between the open position at the closed position in a lid-like movement.

The insertion element may be mechanically connected with the extraction element via an elastic strip, preferably via a metal strip.

The elastic strip may enable transfer of the pivotally movement of the insertion element to the axial movement of the extraction element. In other words, the pivotally opening movement of the insertion element may lead to a pulling action on the extraction element thereby pushing the substrate plug out of the heating module. The pivotally closing movement of the insertion element may lead to a pushing action on the extraction element into the closed position.

The elastic strip may be rigid enough to enable transfer of the mechanical force from the pivotal movement of the insertion element to the extraction element. Providing the elastic strip as a metal strip may be particularly preferred for this purpose.

The insertion element may comprise a rounded portion over which the elastic strip may be arranged such that an opening pivotal movement of the insertion element leads to a pulling action of the elastic strip onto the extraction element, preferably wherein a closing pivotal movement of the insertion element leads to a pushing action of the elastic strip onto the extraction element.

The rounded portion may act as a lever transferring the pivotal movement of the insertion element towards an axial movement of the extraction element. This may be achieved by running the elastic strip over the rounded portion. The rounded portion may be part of a hinge of the mouthpiece connecting the mouthpiece with the rest of the aerosol-generating device.

The invention further relates to an aerosol-generating device that may comprise a side opening configured for insertion and removal of a substrate plug comprising aerosol-forming substrate The aerosol-generating device may further comprise a heating module configured to receive the substrate plug. The heating module may be axially movable between an open position and a closed position. The side opening may be blocked by the heating module when the heating module may be in the closed position. The side opening may be open for receiving the substrate plug or for removal of the substrate plug when the heating module may be in the open position.

The invention further relates to an aerosol-generating device comprising a side opening configured for insertion and removal of a substrate plug comprising aerosol-forming substrate The aerosol-generating device further comprises a heating module configured to receive the substrate plug. The heating module is axially movable between an open position and a closed position. The side opening is blocked by the heating module when the heating module is in the closed position. The side opening is open for receiving the substrate plug or for removal of the substrate plug when the heating module is in the open position.

The side opening may be arranged in a housing of the aerosol-generating device. The side opening may fluidly connect the ambient environment with the substrate plug receiving region.

The heating module may be movable in a distal direction from the closed position to the open position. Alternatively, but less preferred, the heating module may be movable in a proximal direction from the closed position to the open position.

In other words, in contrast to the first two embodiments described herein, in which the heating module may be stationary and the substrate plug receiving region is movable from the closed position to the open position and vice versa, the heating module may be movable in this embodiment. At the same time, the substrate plug receiving region may remain in the same place.

The heating module may be configured slidable over the substrate plug so as to receive the substrate plug when the substrate plug is inserted through the side opening and when the heating module is moved from the open position to the closed position.

The heating module may be mechanically connected to a sliding shaft. The sliding shaft may be mechanically connected to a sliding button arranged on an exterior of the aerosol-generating device.

Actuation of the sliding button may move the sliding shaft. A user may thus manually move the heating module from the closed position to the open position and vice versa.

The heating module may comprise a heating element arranged at least partly surrounding a cavity configured for receiving the substrate plug.

The invention further relates to an aerosol-generating system comprising an aerosol-generating device as described herein and a substrate plug comprising aerosol-forming substrate.

The aerosol-forming substrate may be solid.

As used herein, the terms ‘proximal’, ‘distal’, ‘downstream’ and ‘upstream’ are used to describe the relative positions of components, or portions of components, of the aerosol-generating device in relation to the direction in which a user draws on the aerosol-generating device during use thereof.

The aerosol-generating device may comprise a mouth end through which in use an aerosol exits the aerosol-generating device and is delivered to a user. The mouth end may also be referred to as the proximal end. In use, a user draws on the proximal or mouth end of the aerosol-generating device in order to inhale an aerosol generated by the aerosol-generating device. Alternatively, a user may directly draw on an substrate plug or substrate plug inserted into an opening at the proximal end of the aerosol-generating device. The opening at the proximal end may be an opening of the cavity. The cavity may be configured to receive the substrate plug. The aerosol-generating device comprises a distal end opposed to the proximal or mouth end. The proximal or mouth end of the aerosol-generating device may also be referred to as the downstream end and the distal end of the aerosol-generating device may also be referred to as the upstream end. Components, or portions of components, of the aerosol-generating device may be described as being upstream or downstream of one another based on their relative positions between the proximal, downstream or mouth end and the distal or upstream end of the aerosol-generating device.

As used herein, an ‘aerosol-generating device’ relates to a device that interacts with an aerosol-forming substrate to generate an aerosol. The aerosol-forming substrate may be part of an substrate plug, for example part of a smoking article. An aerosol-generating device may be a smoking device that interacts with an aerosol-forming substrate of an substrate plug to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

As used herein with reference to the present invention, the term ‘smoking’ with reference to a device, article, system, substrate, or otherwise does not refer to conventional smoking in which an aerosol-forming substrate is fully or at least partially combusted. The aerosol-generating device of the present invention is arranged to heat the aerosol-forming substrate to a temperature below a combustion temperature of the aerosol-forming substrate, but at or above a temperature at which one or more volatile compounds of the aerosol-forming substrate are released to form an inhalable aerosol.

The aerosol-generating device may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The cavity of the aerosol-generating device may have an open end into which the substrate plug is inserted. The open end may be a proximal end. The cavity may have a closed end opposite the open end. The closed end may be the base of the cavity. The closed end may be closed except for the provision of air apertures arranged in the base. The base of the cavity may be flat. The base of the cavity may be circular. The base of the cavity may be arranged upstream of the cavity. The open end may be arranged downstream of the cavity. The cavity may have an elongate extension. The cavity may have a longitudinal central axis. A longitudinal direction may be the direction extending between the open and closed ends along the longitudinal central axis. The longitudinal central axis of the cavity may be parallel to the longitudinal axis of the aerosol-generating device.

The cavity may be configured as a heating chamber. The cavity may have a cylindrical shape. The cavity may have a hollow cylindrical shape. The cavity may have a shape corresponding to the shape of the substrate plug to be received in the cavity. The cavity may have a circular cross-section. The cavity may have an elliptical or rectangular cross-section. The cavity may have an inner diameter corresponding to the outer diameter of the substrate plug.

An airflow channel may run through the cavity. Ambient air may be drawn into the aerosol-generating device, into the cavity and towards the user through the airflow channel. Downstream of the cavity, a mouthpiece may be arranged or a user may directly draw on the substrate plug. The airflow channel may extend through the mouthpiece.

In any of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold-and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

As described, in any of the aspects of the disclosure, the heating element may be part of an aerosol-generating device. The aerosol-generating device may comprise an internal heating element or an external heating element, or both internal and external heating elements, where “internal” and “external” refer to the aerosol-forming substrate. An internal heating element may take any suitable form. For example, an internal heating element may take the form of a heating blade. Alternatively, the internal heater may take the form of a casing or substrate having different electro-conductive portions, or an electrically resistive metallic tube. Alternatively, the internal heating element may be one or more heating needles or rods that run through the center of the aerosol-forming substrate. Other alternatives include a heating wire or filament, for example a Ni—Cr (Nickel-Chromium), platinum, tungsten or alloy wire or a heating plate. Optionally, the internal heating element may be deposited in or on a rigid carrier material. In one such embodiment, the electrically resistive heating element may be formed using a metal having a defined relationship between temperature and resistivity. In such an exemplary device, the metal may be formed as a track on a suitable insulating material, such as ceramic material, and then sandwiched in another insulating material, such as a glass. Heaters formed in this manner may be used to both heat and monitor the temperature of the heating elements during operation.

An external heating element may take any suitable form. For example, an external heating element may take the form of one or more flexible heating foils on a dielectric substrate, such as polyimide. The flexible heating foils can be shaped to conform to the perimeter of the substrate receiving cavity. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. An external heating element may also be formed using a metal having a defined relationship between temperature and resistivity. In such an exemplary device, the metal may be formed as a track between two layers of suitable insulating materials. An external heating element formed in this manner may be used to both heat and monitor the temperature of the external heating element during operation.

As an alternative to an electrically resistive heating element, the heating element may be configured as an induction heating element. The induction heating element may comprise an induction coil and a susceptor. In general, a susceptor is a material that is capable of generating heat, when penetrated by an alternating magnetic field. When located in an alternating magnetic field. If the susceptor is conductive, then typically eddy currents are induced by the alternating magnetic field. If the susceptor is magnetic, then typically another effect that contributes to the heating is commonly referred to hysteresis losses. Hysteresis losses occur mainly due to the movement of the magnetic domain blocks within the susceptor, because the magnetic orientation of these will align with the magnetic induction field, which alternates. Another effect contributing to the hysteresis loss is when the magnetic domains will grow or shrink within the susceptor. Commonly all these changes in the susceptor that happen on a nano-scale or below are referred to as “hysteresis losses”, because they produce heat in the susceptor. Hence, if the susceptor is both magnetic and electrically conductive, both hysteresis losses and the generation of eddy currents will contribute to the heating of the susceptor. If the susceptor is magnetic, but not conductive, then hysteresis losses will be the only means by which the susceptor will heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate.

As used herein, the term ‘aerosol-generating article’ or ‘substrate plug’ refers to an article or plug comprising an aerosol-forming substrate that is capable of releasing volatile compounds that can form an aerosol. For example, a substrate plug may be a smoking article or plug that generates an aerosol that is directly inhalable into a user's lungs through the user's mouth. A substrate plug may be disposable.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an substrate plug or smoking article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol.

The aerosol-generating substrate preferably comprises homogenised tobacco material, an aerosol-former and water. Providing homogenised tobacco material may improve aerosol generation, the nicotine content and the flavour profile of the aerosol generated during heating of the substrate plug. Specifically, the process of making homogenised tobacco involves grinding tobacco leaf, which more effectively enables the release of nicotine and flavours upon heating.

Below, there is provided a non-exhaustive list of non-limiting examples. Any one or more of the features of these examples may be combined with any one or more features of another example, embodiment, or aspect described herein.

Example 1. An aerosol-generating device comprising:
a heating module configured to receive a substrate plug comprising aerosol-forming substrate,
a movable insertion element, and
an axially movable extraction element,
wherein the insertion element and the extraction element are mechanically coupled such that the insertion element and the extraction element are movable together between an open position and a closed position, wherein the insertion element is configured to push the substrate plug in a distal direction into the heating module when moved from the open position to the closed position, and wherein the extraction element is configured to push the substrate plug in a proximal direction out of the heating module when moved from the closed position to the open position.

Example 2. The aerosol-generating device according to example 1, wherein a substrate plug receiving region is arranged between the insertion element and the extraction element.

Example 3. The aerosol-generating device according to example 2, wherein the substrate plug receiving region is accessible for insertion and removal of the substrate plug in the open position.

Example 4. The aerosol-generating device according to example 2 or 3, wherein the substrate plug receiving region is arranged centrally within the heating module and is configured as a heating chamber in the closed position.

Example 5. The aerosol-generating device according to any examples 2 to 4, wherein the insertion element comprises an airflow channel in fluid contact with the substrate plug receiving region.

Example 6. The aerosol-generating device according to any examples 2 to 5, wherein the extraction element comprises an airflow channel in fluid contact with the substrate plug receiving region.

Example 7. The aerosol-generating device according to any of the preceding examples, wherein the insertion element directly contacts the substrate plug when the substrate plug is received in the aerosol-generating device.

Example 8. The aerosol-generating device according to any of the preceding examples, wherein the extraction element directly contacts the substrate plug when the substrate plug is received in the aerosol-generating device.

Example 9. The aerosol-generating device according to any of the preceding examples, wherein the insertion element is part of a mouthpiece of the aerosol-generating device.

Example 10. The aerosol-generating device according to any of the preceding examples, wherein the aerosol-generating device further comprises a connection shaft mechanically connecting the insertion element and the extraction element, preferably wherein the connection shaft has an extension axis that is parallel to an extension axis of one or both of the insertion element and the extraction element.

Example 11. The aerosol-generating device according to example 10, wherein the insertion element is pivotally mounted on the connection shaft to enable a pivotal movement in a plane perpendicular to the extension axis of the connection shaft.

Example 12. The aerosol-generating device according to any of the preceding examples, wherein the insertion element is configured axially movable.

Example 13. The aerosol-generating device according to any of examples 1 to 9, wherein the insertion element is pivotally mounted on the aerosol-generating device to enable a pivotal movement between the open position and the closed position in a plane parallel to a longitudinal axis of the aerosol-generating device.

Example 14. The aerosol-generating device according to example 13, wherein the pivotal movement of the insertion element is a lid-like movement between the open position and the closed position.

Example 15. The aerosol-generating device according to example 13 or 14, wherein the insertion element is mechanically connected with the extraction element via an elastic strip, preferably via a metal strip.

Example 16. The aerosol-generating device according to example 15, wherein the insertion element comprises a rounded portion over which the elastic strip is arranged such that an opening pivotal movement of the insertion element leads to a pulling action of the elastic strip onto the extraction element, preferably wherein a closing pivotal movement of the insertion element leads to a pushing action of the elastic strip onto the extraction element.

Example 17. An aerosol-generating device comprising:
a side opening configured for insertion and removal of a substrate plug comprising aerosol-forming substrate, and
a heating module configured to receive the substrate plug, wherein the heating module is axially movable between an open position and a closed position,
wherein the side opening is blocked by the heating module when the heating module is in the closed position, wherein the side opening is open for receiving the substrate plug or for removal of the substrate plug when the heating module is in the open position.

Example 18. The aerosol-generating device according to example 17, wherein the heating module is movable in a distal direction from the closed position to the open position.

Example 19. The aerosol-generating device according to example 17 or 18, wherein the heating module is configured slidable over the substrate plug so as to receive the substrate plug when the substrate plug is inserted through the side opening and when the heating module is moved from the open position to the closed position.

Example 20. The aerosol-generating device according to any of examples 17 to 19, wherein the heating module is mechanically connected to a sliding shaft, preferably wherein the sliding shaft is mechanically connected to a sliding button arranged on an exterior of the aerosol-generating device.

Example 21. The aerosol-generating device according to any of the preceding examples, wherein the heating module comprises a heating element arranged at least partly surrounding a cavity configured for receiving the substrate plug.

Example 22. An aerosol-generating system comprising an aerosol-generating device according to any of the preceding examples and a substrate plug comprising aerosol-forming substrate.

Example 23. The aerosol-generating system of example 22, wherein the aerosol-forming substrate is solid.

Features described in relation to one embodiment may equally be applied to other embodiments of the invention.

The invention will be further described, by way of example only, with reference to the accompanying drawings in which:

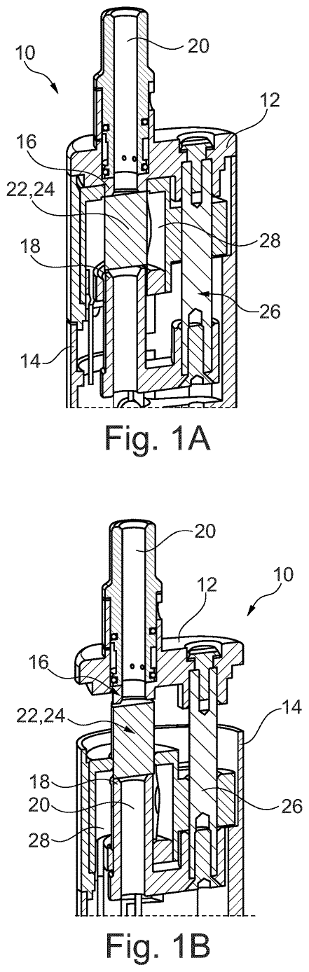

FIGS. 1A and 1B show a first embodiment of an aerosol-generating device comprising an insertion element and an extraction element;

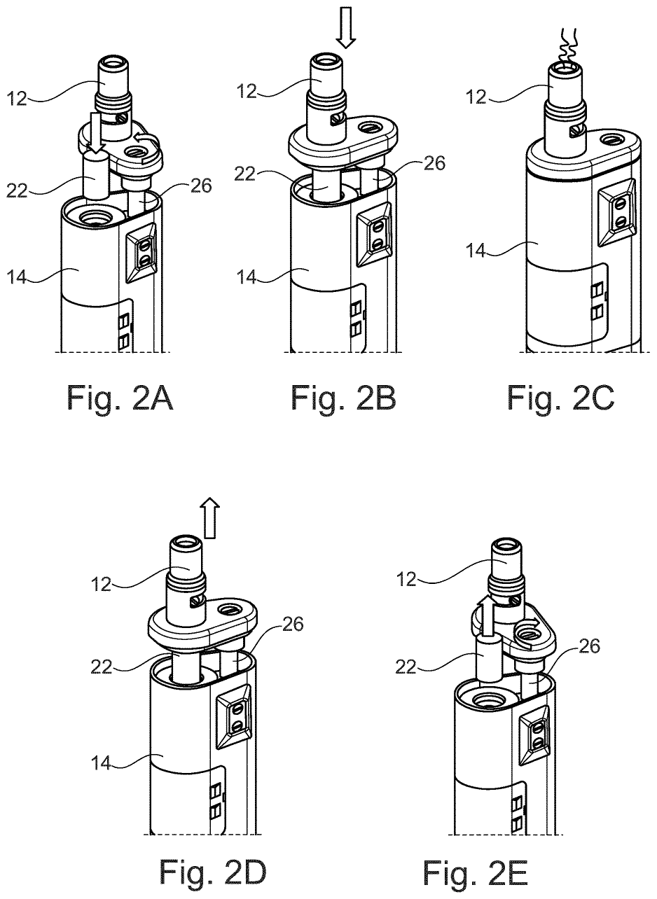

FIGS. 2A to 2E show insertion and removal of a substrate plug in the aerosol-generating device of the first embodiment;

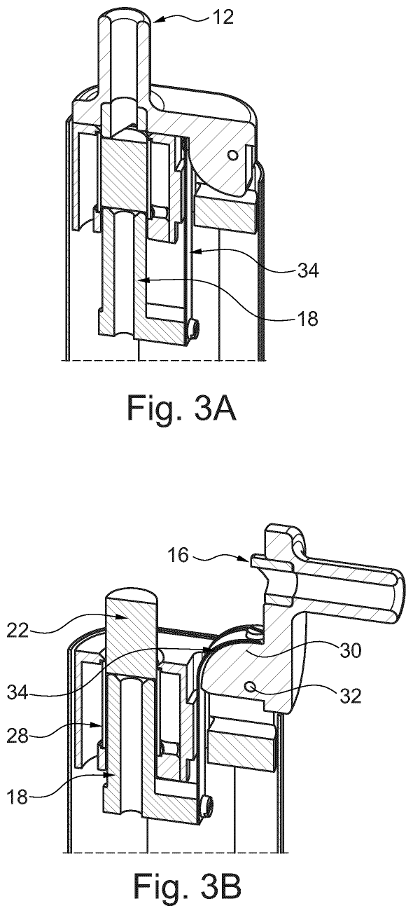

FIGS. 3A and 3B show a second embodiment of the aerosol-generating device in which a mouthpiece is pivotally mounted on a main body of the aerosol-generating device;

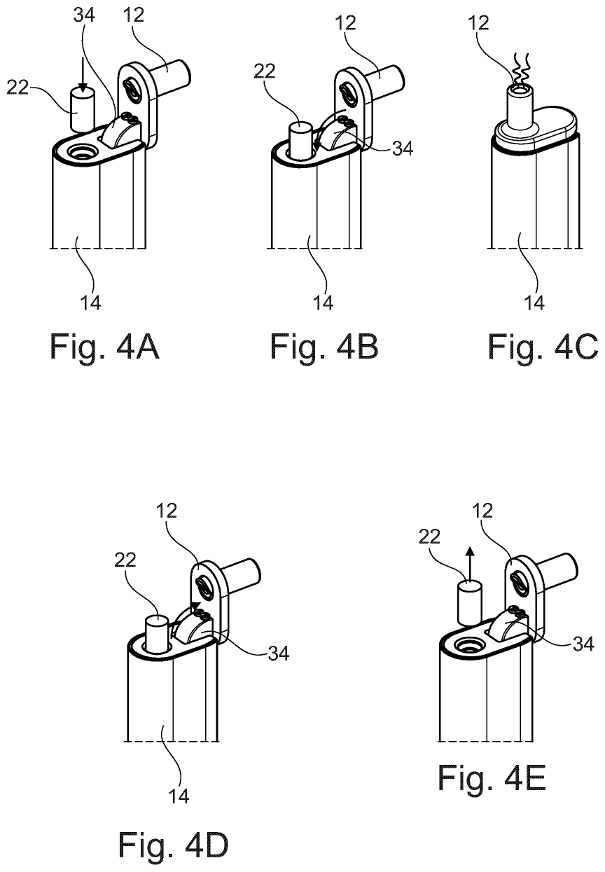

FIGS. 4A to 4E show insertion and removal of a substrate plug in the aerosol-generating device of the second embodiment;

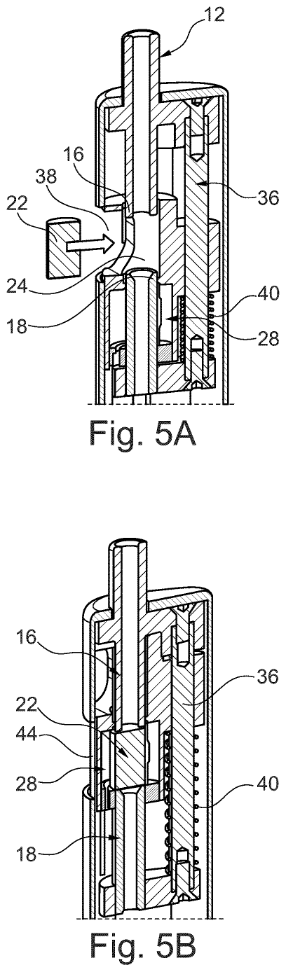

FIGS. 5A and 5B show a third embodiment of the aerosol-generating device in which the mouthpiece is stationary and a heating module is axially movable and a side opening is provided in the main body of the aerosol-generating device; and

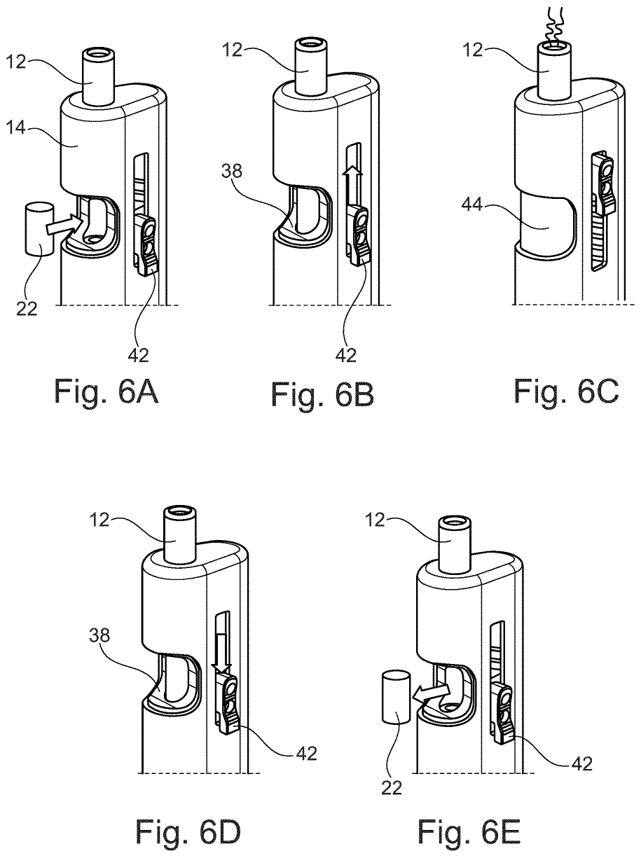

FIGS. 6A to 6E show insertion and removal of a substrate plug in the aerosol-generating device of the third embodiment.

FIGS. 1A and 1B show a first embodiment of an aerosol-generating device 10. The aerosol-generating device 10 comprises a mouthpiece 12 and a main body 14. The mouthpiece 12 comprises the insertion element 16. The extraction element 18 is arranged in the main body 14. The main body 14 may comprise further components such as a power supply and a controller for controlling supply of electrical energy of the power supply to a heating element.

The insertion element 16 is integrally formed with the mouthpiece 12. The insertion element 16 is a tubular element. An airflow channel 20 is arranged centrally within the insertion element 16. The airflow channel 20 continues through the mouthpiece 12 so that a user can inhale aerosol generated by the aerosol-generating device 10. The insertion element 16 protrudes from the mouthpiece 12 at a distal end of the mouthpiece 12. The insertion element 16 has a distal end face that is configured to contact a substrate plug 22 comprising aerosol-forming substrate.

The substrate plug 22 shown in FIGS. 1A and 1B occupies the space of a substrate plug receiving region 24. The substrate plug receiving region 24 is arranged between the insertion element 16 and the extraction element 18. The substrate plug receiving region 24 is shaped to allow receiving of the substrate plug 22.

The extraction element 18 is mechanically connected with the insertion element 16 via a connection shaft 26. The connection shaft 26 is mounted axially movable with respect to the main body 14 of the aerosol-generating device 10. The connection shaft 26 is elongate. The connection shaft 26 extends parallel to a longitudinal axis of the aerosol-generating device 10. The connection shaft 26 is mechanically connected to the insertion element 16 via the mouthpiece 12. The connection shaft 26 is rigidly connected with the extraction element 18. Contrary, the insertion element 16 is rotatably mounted on the connection shaft 26 in a plane perpendicular to the longitudinal axis of the aerosol-generating device 10. With respect to an axial direction, the insertion element 16 is rigidly mounted on the connection shaft 26. This mounting arrangement leads to a simultaneous axial movement of the insertion element 16 and of the extraction element 18 together with the connection shaft 26.

This simultaneous axial movement of the insertion element 16 and of the extraction element 18 together with the connection shaft 26 is illustrated between FIGS. 1A and 1B. In FIG. 1A, the insertion element 16 and the extraction element 18 are in a closed position. In this position, the insertion element 16 and of the extraction element 18 are in a distal position and the substrate plug receiving region 24 in which the substrate plug 22 is arranged in positioned within the main body 14 of the aerosol-generating device 10. Within the main body 14, a heating module 28 is arranged. The heating module 28 comprises a heating chamber and the heating element is arranged at last partly surrounding the heating chamber. The heating chamber is the speat occupied in FIG. 1A by the substrate plug receiving region 24 and the substrate plug 22. In FIG. 1B, the insertion element 16 and the extraction element 18 are moved in a proximal direction. This movement pushes, by means of the extraction element 18, the substrate plug 22 out of the heating chamber of the heating module 28. A rotational movement of the mouthpiece 12 and thus the insertion element 16 as described in more detail with respect to FIG. 2 below leads to an open position of the insertion element 16 and the extraction element 18. In this position, the substrate plug 22 can be removed and replaced by a fresh substrate plug 22. After returning the mouthpiece 12 and the insertion element 16 into the position shown in FIG. 1B, the insertion element 16 can then push the substrate plug 22 back into the heating chamber of the heating module 28 to resume operation.

Similar to the construction of the insertion element 16, the extraction element 18 has a tubular shape to enable the airflow channel 20 to run centrally through the extraction element 18. The airflow channel 20 thus enables air to be drawn through the extraction element 18 and into the heating chamber of the heating module 28 in the closed position. The air can subsequently flow through the insertion element 16 and the mouthpiece 12 to be inhaled by a user.

FIGS. 2A to 2E show insertion and removal of the substrate plug 22 in the aerosol-generating device 10. In FIG. 2A, a fresh substrate plug 22 is inserted into the substrate plug receiving region 24. During the insertion, the insertion element 16 and the extraction element 18 are in the proximal position. Additionally, the insertion element 16 is rotated open to expose the substrate plug receiving region 24. The substrate plug 22 can then be inserted into the substrate plug receiving region 24. In the next step, as shown in FIG. 2B, the insertion element 16 is rotated closed to cover the proximal end of the substrate plug 22. In other words, the insertion element 16 is rotated in place to abut the substrate plug receiving region 24 and to be able to subsequently push the substrate plug 22 into the heating chamber of the heating mode. This step is shown in FIG. 2C, in which the insertion element 16 pushes the substrate plug 22 in a distal direction into the heating chamber of the heating module 28 for aerosol generation. Depending upon the frame of reference, instead of pushing the mouthpiece 12 and the insertion element 16 in a distal direction into the stationary main body 14 of the aerosol-generating device 10, the same operation can be described as pushing the main body 14 of the aerosol-generating device 10 in a proximal direction towards the stationary mouthpiece 12 and insertion element 16.

FIG. 2D shows the start of the removal of the spend substrate plug 22. In order to facilitate the removal, the mouthpiece 12, the insertion element 16 and the extraction element 18 are moved in a proximal direction so that the extraction element 18 pushes the substrate plug 22 out of the heating chamber of the heating module 28. Subsequently, as shown in FIG. 2E, the mouthpiece 12 and the insertion element 16 are rotated open so that the spend substrate plug 22 can be removed. After that, a fresh substrate plug 22 can be inserted as shown in FIG. 2A and the process can be repeated. As previously described the movement of the insertion element 16 and the extraction element 18 is facilitated by connecting the two element via the connection shaft 26 in a way that the extraction element 18 can only be moved in an axial direction while the insertion element 16 can be moved in an axial direction and rotated in a plane perpendicular to the axial direction.

FIGS. 3A and 3B show a second embodiment of the aerosol-generating device 10. In this embodiment, the mouthpiece 12 is pivotally mounted on the main body 14 of the aerosol-generating device 10. The mouthpiece 12 comprises a rounded portion 30 adjacent a hinge 32. The hinge 32 facilitates the pivotal mounting of the mouthpiece 12.

An elastic strip 34, preferably a metal strip, is provided running over the rounded portion 30. The elastic strip 34 establishes the mechanical connection between the mouthpiece 12 comprising the insertion element 16 and the extraction element 18. The rounded portion 30 acts as a lever so that a pivotal opening movement of the mouthpiece 12 and of the insertion element 16 is translated, via the elastic strip 34, to an axial movement of the extraction element 18. In other words, the pivotal opening movement of the mouthpiece 12 leads to a pulling action of onto the extraction element 18. The pivotal opening movement of the mouthpiece 12 is a lid-like movement. The opening movement of the mouthpiece 12 is in a plane parallel to the longitudinal axis of the aerosol-generating device 10.

FIG. 3A shows the closed position of the insertion element 16 and the extraction element 18. Similar to the closed position described in the first embodiment, the substrate plug 22 is in the closed position arranged in the heating chamber of the heating module 28 for aerosol generation. The elastic strip 34 is in this position straight. In FIG. 3B, the mouthpiece 12 is opened. As a consequence, the elastic strip 34 pulls at the extraction element 18 which pushed the substrate plug 22 out of the main body 14 of the aerosol-generating device 10. Due to the pivotal movement of the mouthpiece 12, the mouthpiece 12 and the insertion element 16 are out of the way in his open position so that a further rotational movement of the mouthpiece 12 to access the spend substrate plug 22 is unnecessary. Instead, the substrate plug 22 can be accessed and replaced in the open position of the mouthpiece 12 as shown in FIG. 3B.

Similar to FIGS. 2A to 2E, FIGS. 4A to 4E show insertion of a fresh substrate plug 22 (FIG. 4A), closing of the mouthpiece 12 from open to closed position (FIG. 4B), operation of the aerosol-generating device 10 (FIG. 4C), opening the mouthpiece 12 from closed to open position (FIG. 4D) and removal of the spend substrate plug 22 (FIG. 4E). In contrast to the first embodiment, single movement facilitates to opening (pivotal movement) instead of the two movement configuration of the first embodiment (axial movement followed by rotational movement). The same is true for the closing movement of the mouthpiece 12.

FIGS. 5A and 5B show a third embodiment of the aerosol-generating device 10. In this embodiment, the mouthpiece 12 is stationary. Instead, the heating module 28 is axially movable and a side opening 38 is provided in the main body 14 of the aerosol-generating device 10. The heating module 28 is slidably mounted onto a heating module shaft 36 to facilitate the axial movement of the heating module 28. A biasing element 40 in the form of a spring biases the heating module 28 towards a proximal direction. When the heating module 28 is in a proximal position, as shown in FIG. 5A, the heating module 28 is in an open position. In this position, the substrate plug receiving region 24 is accessible from outside of the aerosol-generating device 10 by means of the side opening 38. A fresh substrate plug 22 can thus be laterally inserted into the side opening 38 and into the substrate plug receiving region 24. Subsequently, as shown in FIG. 5B, the heating module 28 is pushed in a distal direction against the biasing force of the biasing element 40 into the closed position. In this position, the heating module 28 is pushed over the substrate plug receiving region 24 so that the substrate plug 22 is arranged in the heating chamber of the heating module 28. A sidewall 44 of the heating module 28 closes of the side opening 38 in this position to disable access to the substrate plug 22. The movement of the heating module 28, particularly the distal movement from the open to the closed position, is facilitated by a push button 42 (shown in below discussed FIG. 6). The push button 42 is mechanically connected with the heating module 28. The push button 42 is arranged on the outer periphery of the aerosol-generating device 10 to enable a user to manipulate the push button 42.

FIGS. 6A to 6E show, similar to FIGS. 2A to 2E and 4A to 4E, insertion of a fresh substrate plug 22 (FIG. 6A), closing of the side opening 38 from open to closed position (FIG. 6B), operation of the aerosol-generating device 10 (FIG. 6C), opening the side opening 38 from closed to open position (FIG. 6D) and removal of the spend substrate plug 22 (FIG. 6E). FIG. 6 further shows the push button 42 for actuating the movement of the heating module 28, at least of the distal (closing) movement of the heating module 28. Due to the biasing force of the biasing element 40, the proximal (opening) movement of the heating module 28 may be automatic.

1.-15. (canceled)

16. An aerosol-generating device, comprising:
a heating module configured to receive a substrate plug comprising aerosol-forming substrate;
a movable insertion element; and
an axially movable extraction element,
wherein the insertion element and the extraction element are mechanically coupled such that the insertion element and the extraction element are movable together between an open position and a closed position,
wherein the insertion element is configured to push the substrate plug in a distal direction into the heating module when moved from the open position to the closed position, and
wherein the extraction element is configured to push the substrate plug in a proximal direction out of the heating module when moved from the closed position to the open position.

17. The aerosol-generating device according to claim 16, wherein a substrate plug receiving region is arranged between the insertion element and the extraction element.

18. The aerosol-generating device according to claim 17, wherein the substrate plug receiving region is accessible for insertion and removal of the substrate plug in the open position.

19. The aerosol-generating device according to claim 17, wherein the substrate plug receiving region is arranged centrally within the heating module and is configured as a heating chamber in the closed position.

20. The aerosol-generating device according to claim 16, wherein one or both of the insertion element and the extraction element directly contacts the substrate plug when the substrate plug is received in the aerosol-generating device.

21. The aerosol-generating device according to claim 16, wherein the insertion element is part of a mouthpiece of the aerosol-generating device.

22. The aerosol-generating device according to claim 16, further comprising a connection shaft mechanically connecting the insertion element and the extraction element.

23. The aerosol-generating device according to claim 22, wherein the connection shaft has an extension axis that is parallel to an extension axis of one or both of the insertion element and the extraction element.

24. The aerosol-generating device according to claim 23, wherein the insertion element is pivotally mounted on the connection shaft to enable a pivotal movement in a plane perpendicular to the extension axis of the connection shaft.

25. The aerosol-generating device according to claim 16, wherein the insertion element is pivotally mounted on the aerosol-generating device to enable a pivotal movement between the open position and the closed position in a plane parallel to a longitudinal axis of the aerosol-generating device.

26. The aerosol-generating device according to claim 25, wherein the pivotal movement of the insertion element is a lid-like movement between the open position and the closed position.

27. The aerosol-generating device according to claim 25, wherein the insertion element is mechanically connected with the extraction element via an elastic strip.

28. The aerosol-generating device according to claim 27, wherein the insertion element comprises a rounded portion over which the elastic strip is arranged such that an opening pivotal movement of the insertion element leads to a pulling action of the elastic strip onto the extraction element.

29. The aerosol-generating device according to claim 28, wherein a closing pivotal movement of the insertion element leads to a pushing action of the elastic strip onto the extraction element.

30. An aerosol-generating device, comprising:
a side opening configured for insertion and removal of a substrate plug comprising aerosol-forming substrate, and
a heating module configured to receive the substrate plug, wherein the heating module is axially movable between an open position and a closed position,
wherein the side opening is blocked by the heating module when the heating module is in the closed position, and
wherein the side opening is open for receiving the substrate plug or for removal of the substrate plug when the heating module is in the open position.

31. The aerosol-generating device according to claim 30, wherein the heating module is configured slidable over the substrate plug so as to receive the substrate plug when the substrate plug is inserted through the side opening and when the heating module is moved from the open position to the closed position.

32. The aerosol-generating device according to claim 30, wherein the heating module is mechanically connected to a sliding shaft.

33. The aerosol-generating device according to claim 32, wherein the sliding shaft is mechanically connected to a sliding button arranged on an exterior of the aerosol-generating device.

34. An aerosol-generating system, comprising:
the aerosol-generating device according to claim 30; and
a substrate plug comprising aerosol-forming substrate.

35. The aerosol-generating system of claim 34, wherein the aerosol-forming substrate is solid.
